(19) United States
(12) Patent Application Publication
(10) Pub. No.: US 2025/0293996 A1
(43) Pub. Date: Sep. 18, 2025

(54) EFFICIENT PACKET PROCESSING IN A SHARED MEMORY REGION

(71) Applicant: Kratos Integral Holdings LLC, San Diego, CA (US)

(72) Inventor: Sebastian Kuschel, Fredrikstad (NO)

(73) Assignee: Kratos Integral Holdings LLC, San Diego, CA (US)

(21) Appl. No.: 18/603,923

(22) Filed: Mar. 13, 2024

(51) Int. Cl. H04L 49/901; H04B 7/185

(52) U.S. Cl. CPC H04L 49/901; H04B 7/18513; H04L 2212/00

(57) ABSTRACT

Described herein are systems, methods, and other techniques for processing data packets at a compute infrastructure. An application running on the compute infrastructure allocates a region of a memory for a network interface controller to write or read inbound or outbound data packets. A data packet is received at the network interface controller. The data packet is directly written to the region of the memory. A section of the region of the memory adjacent to the data packet is reserved as headroom such that a memory address occupied by the data packet is adjacent to a memory address occupied by the headroom. The application processes the data packet at the region of the memory by adding data to the data packet, wherein adding the data to the data packet causes the data packet to use at least a portion of the headroom.

### BACKGROUND OF THE INVENTION

Satellite communication systems play a crucial role in facilitating global connectivity across diverse applications, including telecommunications, broadcasting, internet services, and remote sensing. These systems operate by transmitting signals between ground-based Earth stations and satellites in orbit. The efficiency and reliability of such systems are important to addressing the increasing demands of contemporary communication and data services. Presently, communications engineers encounter numerous challenges, with a key concern being the optimization of information transmission over limited resources. Given the scarcity of available frequencies for radio signal communication and the rapid growth in the volume of information to be conveyed, there is a need to maximize the efficiency of available frequencies through the use of new hardware and software solutions at the ground stations, terminals, and satellites that make up such communication systems.

### SUMMARY OF THE INVENTION

A summary of the various embodiments of the invention is provided below as a list of examples. As used below, any reference to a series of examples is to be understood as a reference to each of those examples disjunctively (e.g., “Examples 1-4” is to be understood as “Examples 1, 2, 3, or 4”).

Example 1 is a method of processing data packets at a compute infrastructure, the method comprising: allocating, by an application running on the compute infrastructure, a region of a memory for a network interface controller to write or read inbound or outbound data packets; receiving a data packet at the network interface controller; directly writing the data packet to the region of the memory; reserving a section of the region of the memory adjacent to the data packet as headroom such that a memory address occupied by the data packet is adjacent to a memory address occupied by the headroom; and processing, by the application, the data packet at the region of the memory by adding data to the data packet, wherein adding the data to the data packet causes the data packet to use at least a portion of the headroom.

Example 2 is the method of example(s) 1, further comprising: in response to allocating the region of the memory, instructing, by the application, the network interface controller to read or write the outbound or inbound data packets from/to the region of the memory.

Example 3 is the method of example(s) 1, further comprising: receiving a second data packet at the network interface controller, wherein the data packet is a first data packet; directly writing the second data packet to the region of the memory; reserving a second section of the region of the memory adjacent to the second data packet as second headroom such that a memory address occupied by the second data packet is adjacent to a memory address occupied by the second headroom; and processing, by the application, the second data packet at the region of the memory by adding second data to the data packet, wherein adding the second data to the second data packet causes the second data packet to use at least a portion of the second headroom; wherein processing the first data packet and the second data packet includes encapsulating the first data packet and the second data packet within a baseband frame for transmission via a satellite.

Example 4 is the method of example(s) 1, further comprising: in response to writing the data packet to the region of the memory, sending, by the network interface controller, an event to the application indicating that the data packet has been written to the region of the memory.

Example 5 is the method of example(s) 4, wherein the event further indicates the memory address occupied by the data packet.

Example 6 is the method of example(s) 1, wherein processing the data packet at the region of the memory further includes: encapsulating the data packet within a baseband frame for transmission via a satellite.

Example 7 is the method of example(s) 1, wherein the application includes one or more virtual network functions (VNF) running on the compute infrastructure.

Example 8 is the method of example(s) 1, wherein the compute infrastructure is part of a gateway of a satellite communication system.

Example 9 is the method of example(s) 1, wherein the compute infrastructure is part of a terminal of a satellite communication system.

Example 10 is the method of example(s) 1, wherein the data packet is received over a terrestrial network.

Example 11 is a non-transitory computer-readable medium comprising instructions that, when executed by one or more processors, cause the one or more processors to perform operations for processing data packets at a compute infrastructure, the operations comprising: allocating, by an application running on the compute infrastructure, a region of a memory for a network interface controller to write or read inbound or outbound data packets; receiving a data packet at the network interface controller; directly writing the data packet to the region of the memory; reserving a section of the region of the memory adjacent to the data packet as headroom such that a memory address occupied by the data packet is adjacent to a memory address occupied by the headroom; and processing, by the application, the data packet at the region of the memory by adding data to the data packet, wherein adding the data to the data packet causes the data packet to use at least a portion of the headroom.

Example 12 is the non-transitory computer-readable medium of example(s) 11, wherein the operations further comprise: in response to allocating the region of the memory, instructing, by the application, the network interface controller to read or write the outbound or inbound data packets from/to the region of the memory.

Example 13 is the non-transitory computer-readable medium of example(s) 11, wherein the operations further comprise: receiving a second data packet at the network interface controller, wherein the data packet is a first data packet; directly writing the second data packet to the region of the memory; reserving a second section of the region of the memory adjacent to the second data packet as second headroom such that a memory address occupied by the second data packet is adjacent to a memory address occupied by the second headroom; and processing, by the application, the second data packet at the region of the memory by adding second data to the data packet, wherein adding the second data to the second data packet causes the second data packet to use at least a portion of the second headroom; wherein processing the first data packet and the second data packet includes encapsulating the first data packet and the second data packet within a baseband frame for transmission via a satellite.

Example 14 is the non-transitory computer-readable medium of example(s) 11, wherein the operations further comprise: in response to writing the data packet to the region of the memory, sending, by the network interface controller, an event to the application indicating that the data packet has been written to the region of the memory.

Example 15 is the non-transitory computer-readable medium of example(s) 14, wherein the event further indicates the memory address occupied by the data packet.

Example 16 is the non-transitory computer-readable medium of example(s) 11, wherein processing the data packet at the region of the memory further includes: encapsulating the data packet within a baseband frame for transmission via a satellite.

Example 17 is the non-transitory computer-readable medium of example(s) 11, wherein the application includes one or more virtual network functions (VNF) running on the compute infrastructure.

Example 18 is the non-transitory computer-readable medium of example(s) 11, wherein the compute infrastructure is part of a gateway of a satellite communication system.

Example 19 is the non-transitory computer-readable medium of example(s) 11, wherein the compute infrastructure is part of a terminal of a satellite communication system.

Example 20 is the non-transitory computer-readable medium of example(s) 11, wherein the data packet is received over a terrestrial network.

Example 21 is a system comprising: one or more processors; and a non-transitory computer-readable medium comprising instructions that, when executed by the one or more processors, cause the one or more processors to perform operations for processing data packets at a compute infrastructure, the operations comprising: allocating, by an application running on the compute infrastructure, a region of a memory for a network interface controller to write or read inbound or outbound data packets; receiving a data packet at the network interface controller;

directly writing the data packet to the region of the memory; reserving a section of the region of the memory adjacent to the data packet as headroom such that a memory address occupied by the data packet is adjacent to a memory address occupied by the headroom; and processing, by the application, the data packet at the region of the memory by adding data to the data packet, wherein adding the data to the data packet causes the data packet to use at least a portion of the headroom.

Example 22 is the system of example(s) 21, wherein the operations further comprise: in response to allocating the region of the memory, instructing, by the application, the network interface controller to read or write the outbound or inbound data packets from/to the region of the memory.

Example 23 is the system of example(s) 21, wherein the operations further comprise: receiving a second data packet at the network interface controller, wherein the data packet is a first data packet; directly writing the second data packet to the region of the memory; reserving a second section of the region of the memory adjacent to the second data packet as second headroom such that a memory address occupied by the second data packet is adjacent to a memory address occupied by the second headroom; and processing, by the application, the second data packet at the region of the memory by adding second data to the data packet, wherein adding the second data to the second data packet causes the second data packet to use at least a portion of the second headroom; wherein processing the first data packet and the second data packet includes encapsulating the first data packet and the second data packet within a baseband frame for transmission via a satellite.

Example 24 is the system of example(s) 21, wherein the operations further comprise: in response to writing the data packet to the region of the memory, sending, by the network interface controller, an event to the application indicating that the data packet has been written to the region of the memory.

Example 25 is the system of example(s) 24, wherein the event further indicates the memory address occupied by the data packet.

Example 26 is the system of example(s) 21, wherein processing the data packet at the region of the memory further includes: encapsulating the data packet within a baseband frame for transmission via a satellite.

Example 27 is the system of example(s) 21, wherein the application includes one or more virtual network functions (VNF) running on the compute infrastructure.

Example 28 is the system of example(s) 21, wherein the compute infrastructure is part of a gateway of a satellite communication system.

Example 29 is the system of example(s) 21, wherein the compute infrastructure is part of a terminal of a satellite communication system.

Example 30 is the system of example(s) 21, wherein the data packet is received over a terrestrial network.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and various ways in which it may be practiced.

FIG. 1 illustrates an example of a compute infrastructure at which a data packet is picked up from a network to be processed.

FIGS. 2A-2D illustrate an example packet processing of a data packet in a shared memory region.

FIGS. 3A-3D illustrate an example packet processing of a set of data packets in a shared memory region.

FIG. 4 illustrates an example of a compute infrastructure having a set of computing devices, a set of memories, and a network interface controller.

FIG. 5 illustrates an example communication path between end points enabled by a satellite communication system.

FIG. 6 illustrates an example satellite communication system including a gateway and a set of terminals.

FIG. 7 illustrates an example digital IF packet with multiple protocol layers.

FIGS. 8A-8C illustrate example traffic adapters implementing different network types.

FIG. 9 illustrates a method of processing data packets at a compute infrastructure.

FIG. 10 illustrates an example computer system comprising various hardware elements.

In the appended figures, similar components and/or features may have the same numerical reference label. Further, various components of the same type may be distinguished by following the reference label with a letter or by following the reference label with a dash followed by a second numerical reference label that distinguishes among the similar components and/or features. If only the first numerical reference label is used in the specification, the description is applicable to any one of the similar components and/or features having the same first numerical reference label, irrespective of the suffix.

### DETAILED DESCRIPTION OF THE INVENTION

Data packets are routinely processed inside satellite communication systems. At a gateway, data packets may be picked up from a terrestrial network, transformed into a different format, and sent out to a digitizer for transmission over a satellite link. On the reception path, data packets are also processed and transformed into different formats so that these packets can be played out to the network. Packet processing can utilize a large amount of processing and memory load at the gateway's compute infrastructure, particularly when transferring high data-rates with small packet sizes.

Embodiments described herein reduce the processing and memory load in satellite communication systems by avoiding or significantly reducing the copying of packets inside memory during processing. Embodiments may accomplish this by using a shared memory between the application, the operating system, and the network interface controller for input/output operations and reserving a memory headroom in front of data packets that are stored in the shared memory. Using the described techniques, experimental results demonstrated that the number of packets processed per second was improved by factor of 10× for a set of central processing unit (CPU) cores.

Embodiments described herein incorporate various features to achieve significant performance improvements over conventional approaches. Some embodiments may avoid costly memory copy operations. For example, some embodiments may avoid any copy operations between the actual hardware, such as the network interface controller, and the software. Some embodiments may avoid copy operations between the isolated layers of the operating system's kernel and the application performing the packet processing operations. Furthermore, when manipulation of data is required, such as during encapsulation of one or more data packets, some embodiments may prevent the bulk of data from being moved or copied. Some embodiments may take into consideration the underlying existing standard hardware so that the hardware itself does not need to copy data, e.g., copying between caches and memory channels when using multi-socket hardware.

In a conventional system, an inbound data packet is copied from the network interface controller into a buffer hosted by the operating system. Since the operating system protects its memory from user-mode applications, the operating system copies the packet data from the buffer into the process of the application. Embodiments of the present disclosure circumvent this copy operation so that the network interface controller can directly write into (or directly read from) the associated shared memory. To use this shared memory, the network interface controller can be instructed by the application (assisted by the operating system) to access the shared memory. Once allocated, the application itself can also operate on the shared memory.

In the following description, various examples will be described. For purposes of explanation, specific configurations and details are set forth in order to provide a thorough understanding of the examples. However, it will also be apparent to one skilled in the art that the example may be practiced without the specific details. Furthermore, well-known features may be omitted or simplified in order not to obscure the embodiments being described.

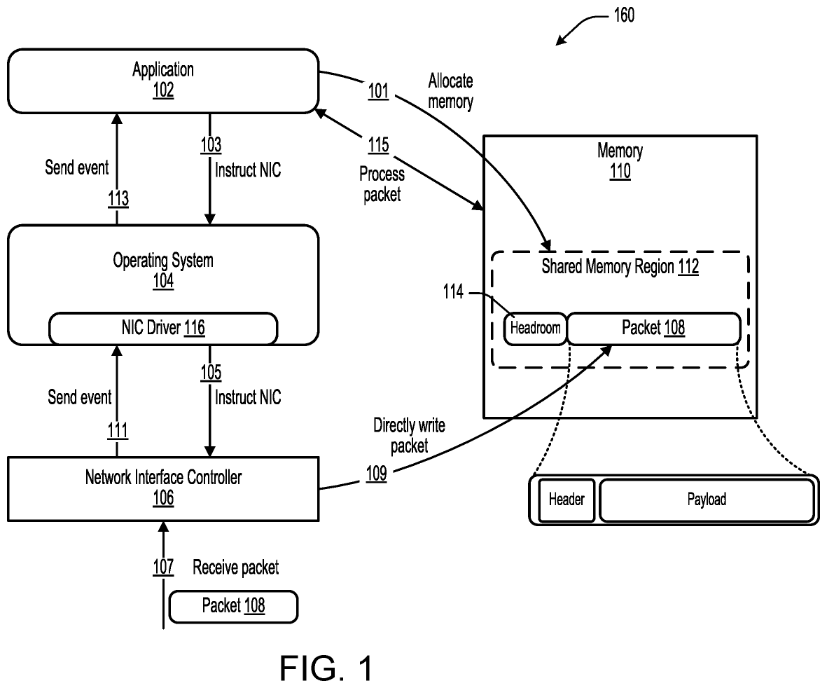

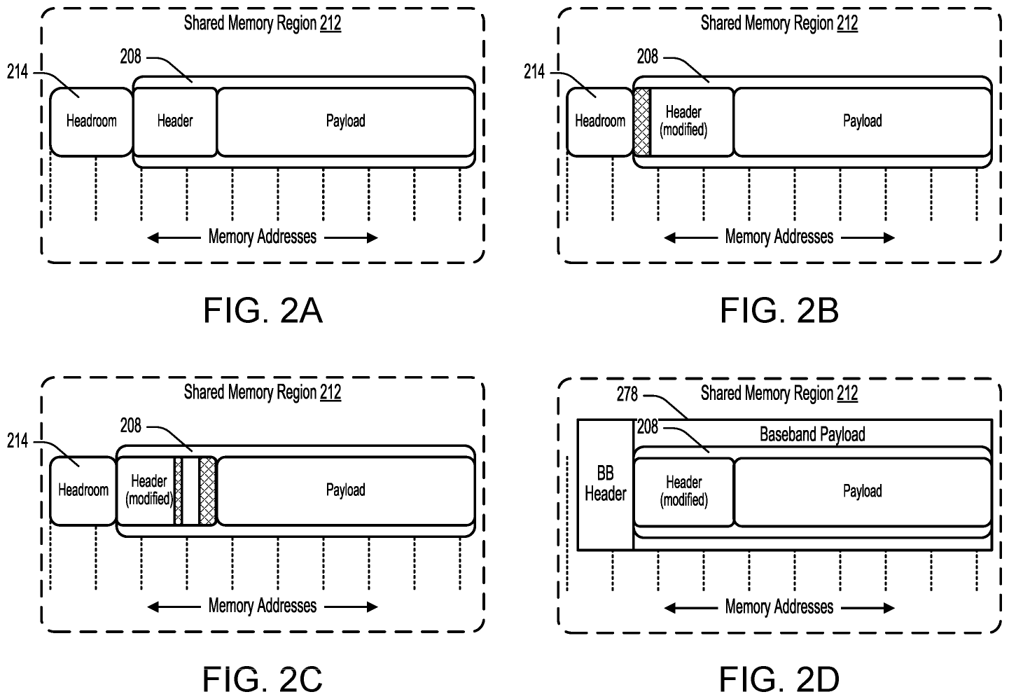

The figures herein follow a numbering convention in which the first digit or digits correspond to the figure number and the remaining digits identify an element or component in the figure. Similar elements or components between different figures may be identified by the use of similar digits. For example, 108 may reference element “08” in FIG. 1, and a similar element may be referenced as 208 in FIG. 2. As will be appreciated, elements shown in the various embodiments herein can be added, exchanged, and eliminated so as to provide a number of additional embodiments of the present disclosure. In addition, the proportion and the relative scale of the elements provided in the figures are intended to illustrate certain embodiments of the present disclosure and should not be taken in a limiting sense.

FIG. 1 illustrates an example of a compute infrastructure 160 at which a data packet 108 is picked up from a network to be processed, in accordance with some embodiments of the present disclosure. Compute infrastructure 160 may be at a gateway, a remote terminal, among other possibilities. Compute infrastructure 160 may include a memory 110, a network interface controller 106, and one or more processors or processor cores communicatively coupled to each other. Software elements running on compute infrastructure 160 may include an application 102, an operating system 104, and a network interface controller (NIC) driver 116 (e.g., each running on the one or more processors or processor cores).

At step 101, application 102 allocates a shared memory region 112 of memory 110 for network interface controller 106 to directly write inbound data packets (or, in some examples, to directly read outbound data packets). Shared memory region 112 may be a contiguous section of memory having consecutive addresses and, in some examples, may have memory protection set such that any of application 102, operating system 104, NIC driver 116, and network interface controller 106 may read from or write to shared memory region 112.

At step 103, application 102 instructs operating system 104 or NIC driver 116 to instruct network interface controller 106 to directly write inbound data packets to shared memory region 112 with reserved headroom (or, in some examples, to directly read outbound data packets). In some examples, application 102 may send an instruction to NIC driver 116, which then relays the instruction to network interface controller 106. The instruction may indicate the memory addresses comprising shared memory region 112, the amount of memory to reserve for the headroom, among other possibilities.

At step 105, NIC driver 116 instructs network interface controller 106 to directly write inbound data packets to shared memory region 112 with reserved headroom.

At step 107, network interface controller 106 receives data packet 108 over a network, such as a terrestrial network. Data packet 108 may be an IP packet, an Ethernet frame, or other protocol data unit (PDU). Network interface controller 106 may check the header of data packet 108 to ensure it is intended for its MAC address (in the case of Ethernet networks). If data packet 108 is addressed to network interface controller 106, or if network interface controller 106 is in promiscuous mode (where it captures all packets on the network), network interface controller 106 performs the write operation at step 109. Otherwise, network interface controller 106 discards the packet.

At step 109, network interface controller 106 directly writes data packet 108 to shared memory region 112 and reserves a section of shared memory region 112 in front of data packet 108 as headroom 114. In some examples, headroom 114 may occupy the memory addresses adjacent to the header of data packet 108. For example, the memory addresses occupied by headroom 114 and the memory addresses occupied by the header of data packet 108 may be contiguous. Headroom 114 may include placeholder data that indicates that the section of shared memory region 112 is reserved.

At step 111, network interface controller 106 sends an event to NIC driver 116 that indicates that data packet 108 and headroom 114 were written to shared memory region 112. The event may indicate the memory addresses at which data packet 108 and headroom 114 were written. In some examples, network interface controller 106 may send the event to NIC driver 116, which then relays the event to application 102.

At step 113, operating system 104 or NIC driver 116 sends the event to application 102 indicating that data packet 108 and headroom 114 were written to shared memory region 112.

At step 115, application 102 begins processing data packet 108 using the section of shared memory region 112 at which headroom 114 was reserved. In some examples, application 102 may first parse data packet 108 to extract information such as source and destination addresses, protocol type, and payload length from the packet header. If data packet 108 is using a protocol that is incompatible with the satellite link or needs adaptation, application 102 may convert the packet's protocol to one suitable for transmission over the satellite network. In some examples, application 102 may add data to data packet 108, causing data packet 108 to use at least a portion of headroom 114. In some examples, application 102 may encapsulate the data packet within a baseband frame together with one or more other data packets.

FIGS. 2A-2D illustrate an example packet processing of a data packet 208 in a shared memory region 212, in accordance with some embodiments of the present disclosure. In FIG. 2A, data packet 208 is written to shared memory region 212 by a network interface controller as described with respect to FIG. 1. Furthermore, the network interface controller may reserve a section of shared memory region 212 in front of data packet 208 as headroom 214. In some examples, headroom 214 may occupy the memory addresses that are adjacent to (e.g., immediately precede) the memory addresses occupied by the header of data packet 208.

In FIGS. 2B and 2C, an application processes data packet 208 by modifying the packet header. In FIG. 2B, the application adds additional data to the front of the packet header (as indicated by the shaded portion) to increase the size of the header, using a first portion of the memory addresses previously occupied by headroom 214. In FIG. 2C, the application modifies different portions at the middle and end of the packet header (as indicated by the shaded portions), changing the data of the header at memory addresses already occupied by the packet header. The modifications to the packet header may correspond to the inserting or removing of tags, rewriting the header type, among other possibilities.

In FIG. 2D, the application further processes data packet 208 by encapsulating data packet 208 within a baseband frame 278. In some examples, data packet 208 may be copied and moved to a new set of memory addresses to be encapsulated within baseband frame 278. Alternatively, in some examples (such as the example illustrated in FIG. 2D), data packet 208 may be encapsulated without copying/moving data packet 208 from the memory addresses it occupied in FIGS. 2B and 2C upon being written to shared memory region 212 by the network interface controller. The baseband header may be written at the memory addresses occupied by headroom 214, using a second portion of the memory addresses previously occupied by headroom 214. In the illustrated example, a third portion of the memory addresses occupied by headroom 214 is used by neither the baseband header nor the baseband payload, which includes the header and payload of data packet 208.

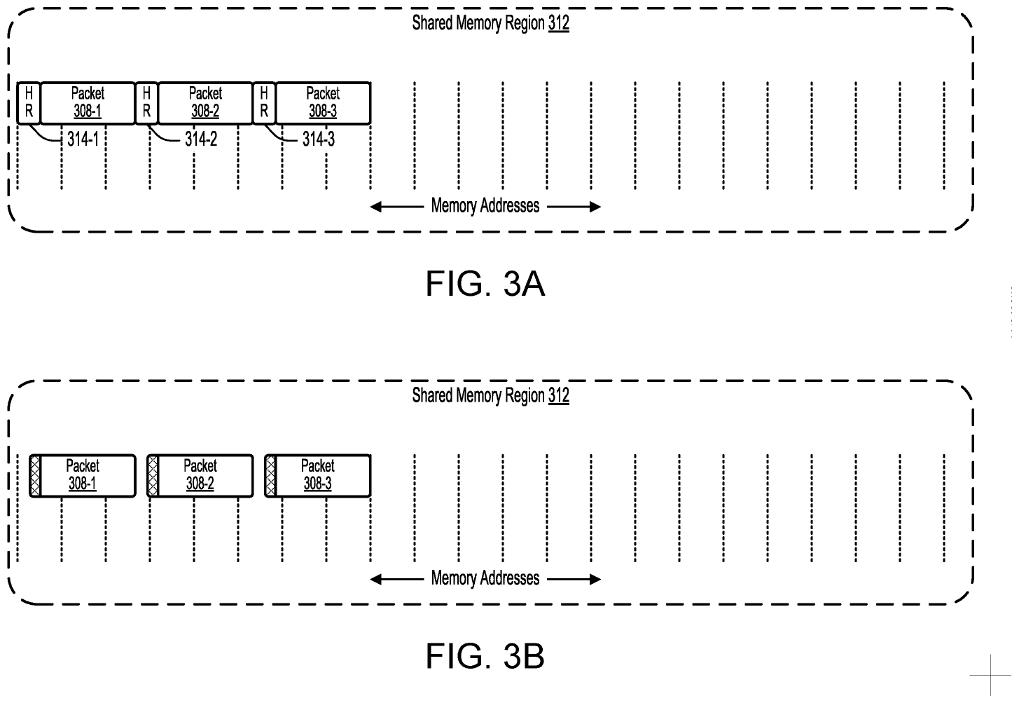

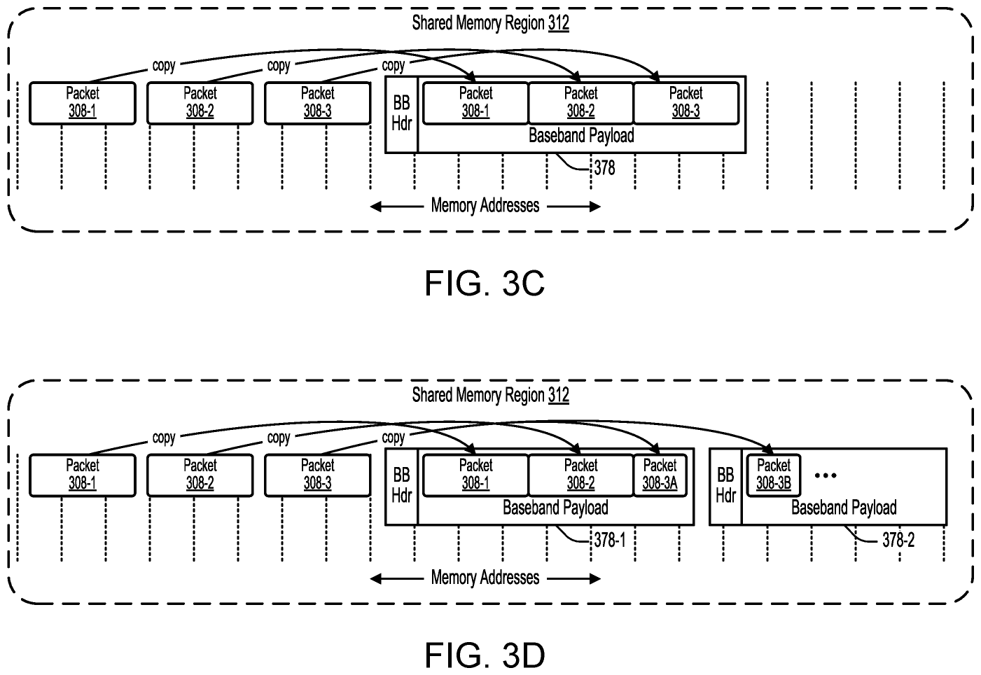

FIGS. 3A-3D illustrate an example packet processing of a set of data packets 308 in a shared memory region 312, in accordance with some embodiments of the present disclosure. In FIG. 3A, data packets 308 are sequentially or concurrently written to shared memory region 312 by a network interface controller. For example, as described in reference to FIG. 1, the network interface controller may directly write data packets 308 to shared memory region 312 in response to the network interface controller receiving data packet 308 over a terrestrial network. Furthermore, the network interface controller may reserve sections of shared memory region 312 in front of data packets 308 as headrooms 314, including a first headroom 314-1 in front of a first data packet 308-1, a second headroom 314-2 in front of a second data packet 308-2, and a third headroom 314-3 in front of a third data packet 308-3. In some examples, headrooms 314 may occupy the memory addresses that are adjacent to (e.g., immediately precede) the memory addresses occupied by the headers of data packets 308.

In FIG. 3B, an application processes data packets 308, increasing the sizes of data packets 308 (as indicated by the shaded portions). In some examples, the application modifies the packet headers of data packets 308 by adding additional data to the front of the headers, causing the data packets 308 to use portions of the memory addresses previously occupied by headrooms 314. The modifications to the packet headers may correspond to the inserting or removing of tags, rewriting the header types, among other possibilities.

In FIG. 3C, the application further processes data packets 308 by encapsulating data packets 308 within a baseband frame 378. The application copies (i.e., reads then writes) data packets 308 to a new set of memory addresses to be encapsulated within baseband frame 378. In the example of FIG. 3C, baseband frame 378 is sufficiently large to contain all of data packets 308. FIG. 3D is similar to FIG. 3C except that the application copies (i.e., reads then writes) data packets 308-1 and 308-2 to a new set of memory addresses to be encapsulated within a first baseband frame 378-1 and data packet 308-3 is split between baseband frame 378-1 and a second baseband frame 378-2. Since baseband frame 378-1 is not sufficiently large to contain all of data packets 308, the application splits data packet 308-3 into data packets 308-3A and 308-3B and copies and moves the packets to be encapsulated by baseband frames 378-1 and 378-2, respectively.

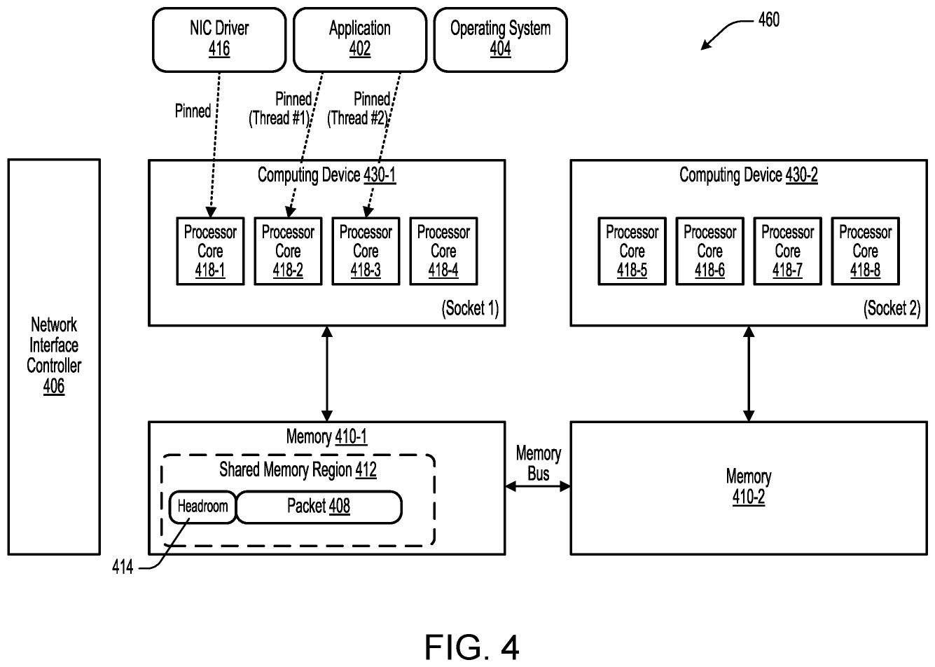

FIG. 4 illustrates an example of a compute infrastructure 460 having a set of computing devices 430, a set of memories 410, and a network interface controller 406, in accordance with some embodiments of the present disclosure. Computing devices 430 may include a first computing device 430-1 (which may correspond to a first socket) and a second computing device 430-1 (which may correspond to a second socket), each including a set of processor cores 418 running a number of software elements optionally including an application 402, an operating system 404, and an NIC driver 416.

Memories 410 may include a first memory 410-1 and a second memory 410-2. Each of memories 410 may include a memory bank that is accessible by a respective one of computing devices 430 as a local memory bank. For example, computing device 430-1 may access memory 410-1 along a fast path and memory 410-2 along a memory bus (or bridge) with a penalty, and computing device 430-2 may access memory 410-2 along a fast path and memory 410-1 along the memory bus with a penalty. Cross socket operations yield a penalty since the data must be transferred via bridges or data-rings. In some instances, a cross-socket operation can take twice the amount of time as a local-socket memory access operation.

To process a data packet 408, operating system 404 may assign application 402 and NIC driver 416 to different processor cores 418 of computing device 430-1. In cases in which application 402 includes multiple threads (e.g., multiple VNFs), each thread may be assigned to one of the different processor cores 418 of computing device 430-1. In some examples, operating system 404 may pin the threads of application 402 and NIC driver 416 to different processor cores 418 so as to not be reassigned to processor cores 418 of another socket, such as those of computing device 430-2. By pinning the required threads of application 402 and NIC driver 416 to the same hardware socket, all data used to process packet 408 need not be brought into the context of the new CPU, which can entail copying the memory into the caches of the reassigned processing cores.

In various examples, data packet 408 may be processed in response to network interface controller 406 receiving data packet 408 via the network (downlink) or in preparation for network interface controller 406 transmitting data packet 408 via the network (uplink). In either case, application 402 may allocate a shared memory region 412 of memory 410-1 for network interface controller 406 to directly read outbound data packets or directly write inbound data packets. A section of shared memory region 412 in front of data packet 408 may be reserved as headroom 414 to allow more efficient processing of data packet 408 and optionally allow processing without moving or copying data packet 408 to another address within memory 410-1.

For outbound data packets, application 402 may write data packet 408 to shared memory region 412 (e.g., by writing the baseband frame that includes the payload of data packet 408) and reserve headroom 414. After application 402 performs one or more packet processing operations (e.g., decapsulation of data packet 408 from a baseband frame), network interface controller 406 may read data packet 408 from shared memory region 412 and send the packet into the network. For inbound data packets, network interface controller 406 may write data packet 408 to shared memory region 412 and reserve headroom 414. After application 402 performs one or more packet processing operations (e.g., encapsulation of data packet 408 within a baseband frame), application 402 may read data packet 408 from shared memory region 412 (e.g., by reading the baseband frame that includes the payload of data packet 408) and send the packet into a digitizer for wireless transmission to a satellite.

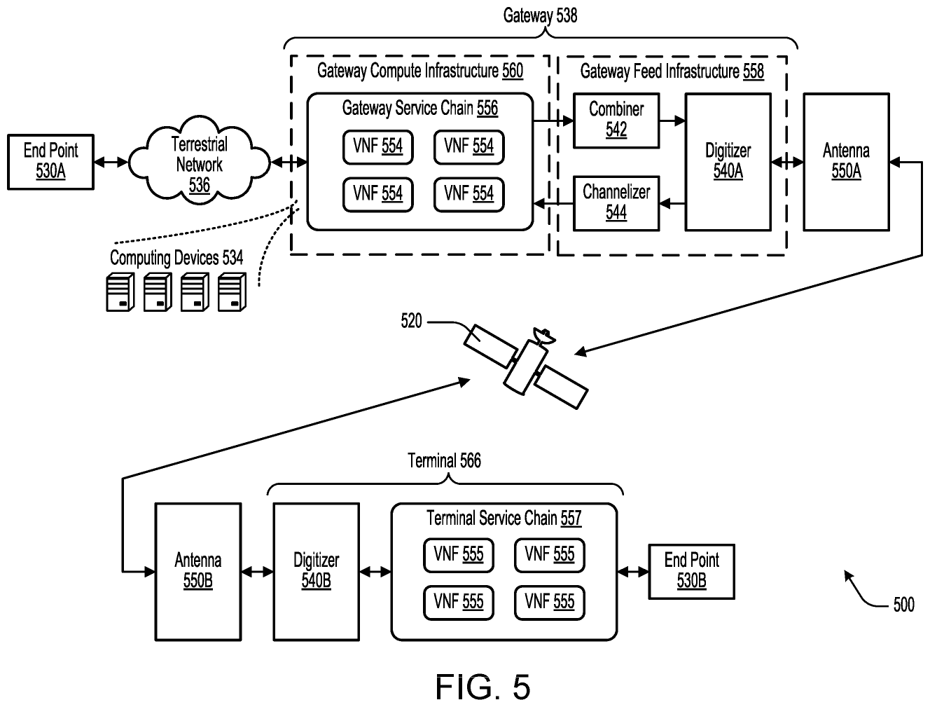

FIG. 5 illustrates an example communication path between an end point 530A and an end point 530B enabled by a satellite communication system 500, in accordance with some embodiments of the present disclosure. In the illustrated example, satellite communication system 500 includes a gateway 538 in communication with a terminal 566 via a satellite 520. In various examples, satellite 520 may send and receive wireless signals within one or more bands of a number of possible frequency bands between 1-300 GHz including, for example, 1 GHz and 300 GHz, including L Band (1-2 GHz), C-Band (4-8 GHZ), X-Band (8-12 GHz), Ku-Band (12-18 GHZ), Ka-Band (26.5-40 GHz), S-Band (2-4 GHZ), and V-Band (40-75 GHz).

In various examples, end points 530 may correspond to portable mobile devices, internet of things (IoT) devices, desktop computers, user terminals, or any of a number of devices with communication capabilities. Alternatively, end points 530 may correspond to networks such as mobile towers, mining sites, ships, planes, or the like. In one example, end point 530A may correspond to a service and end point 530B may correspond to a consumer. It should be understood that the satellite communication environment may comprise other end points 510 and/or other arrangements of components than those illustrated. Furthermore, multiple communication paths may be constructed and operated in parallel, and separate communication paths may have different arrangements from each other.

End point 530A may be communicatively connected via a terrestrial network 536 (e.g., comprising the Internet, a private telecom backbone, or a cloud compute center) to a gateway 538. Gateway 538 may include one or more switches (not shown) to facilitate communication between the various components, such as a first switch at the boundary between terrestrial network 536 and a gateway compute infrastructure 560, and a second switch at the boundary between gateway compute infrastructure 560 and a gateway feed infrastructure 558. Such switches may be physical or virtual Gigabit Ethernet (GigE) switches. However, it should be understood that the above-described first and second switches could be implemented in the same switch. In some examples, the first switch may implement transport from terrestrial network 536 to a VNF 554 within a gateway service chain 556. In such a case, VNF 554 may act as a User Network Interface (UNI) or an External Network-Network Interface (ENNI) as defined by the applicable MEF Ethernet services and MEF operator services standards. Alternatively, the first switch may itself represent the UNI as defined by the applicable MEF standards.

Gateway compute infrastructure 560 may include a set of computing devices 534 situated onsite (at a same physical location) or offsite (at a different physical location) relative to antenna 550. In some examples, computing devices 534 may comprise general-purpose computers or servers capable of running VNFs 554 and other virtualization software such as hypervisors to support gateway service chain 556. In some examples, computing devices 534 may employ x86 architectures, ARM architectures, RISC-V architectures, among other possibilities. Computing devices 534 may be configured as clusters, data centers, warehouse-scale computers, among other possibilities. Gateway compute infrastructure 560 may further include suitable storage systems that provide persistent and reliable storage in support of VNFs 554.

In some examples, gateway compute infrastructure 560 may include a managing system that instantiates and configures one or more VNFs 554 to form gateway service chain 556. Two sets of one or more VNFs 554 may provide two-way communication, including a transmission path and a reception path, between terrestrial network 536 and a gateway feed infrastructure 558 of gateway 556. It should be understood that in an example in which gateway service chain 556 provides only one-way communication, VNFs 554 may provide only a transmission path without providing a reception path. The set of VNFs 554 (e.g., implementing a gateway) on the forward path towards the link to satellite 520, may comprise or constitute a traffic handler, an encapsulator (e.g., implementing generic stream encapsulation (GSE)), a modulator (e.g., the OpenSpace™ Wideband Software modulator, offered by Kratos Defense & Security Solutions, Inc. of San Diego, California), a combiner, an encryption/decryption VNF, a time division multiple access (TDMA) resource allocator, an antenna controller, among other possibilities.

This set of VNFs 554 on the transmission path may convert protocol data units (PDUs) into a digital signal (such as a digital intermediate frequency (IF) waveform or a composite digital IF waveform). For example, the traffic handler may process data link layer (e.g., Layer 2 or L2 in the Open Systems Interconnection (OSI) model) and/or network layer (e.g., Layer 3 or L3 in the OSI model) traffic, and provide the processed Ethernet frames or IP packets to the encapsulator. The encapsulator may convert the PDUs into baseband frames, and provide the baseband frames to the modulator. A baseband frame may be the basic unit of transmission in satellite communication system 500. The encapsulator may form baseband frames in accordance with the 5G standard, the DVB-S2x standard, described in European Telecommunications Standards Institute (ETSI) European Standard (EN) 302 307-1 v1.4.1 (2014-11), among other possible standards. The encapsulator may comprise one or more VNFs 554 (or software subprocesses) that perform one or more of the following functions: frame chopping, forward modulation selection (e.g., with Adaptive Coding and Modulation (ACM)), Ethernet bridge (e.g., Media Access Control (MAC) table, smart bridging/learning/relay, etc.), Address Resolution Protocol (ARP) (e.g., Ethernet MAC discovery), VLAN manipulation (e.g., to rewrite Ethernet frames on ingress/egress based on the MEF service definition), header compression (e.g., Robust Header Compression (ROHC)); and/or OTA optimization (e.g., Space Communications Protocol Specifications (SCPS)/TCP-Acceleration). The modulator may convert the baseband frames into signal data packets in accordance with a particular standard, including the standards of the Digital Intermediate Frequency Interoperability (DIFI) Consortium in the DIFI/Institute of Electrical and Electronics Engineers (IEEE) 1.0 specification, the VMEbus International Trade Association (VITA) standard, the enhanced Common Public Radio Interface (eCPRI) standard, among other possibilities. In an embodiment, the encapsulator and the traffic handler may be implemented as a single VNF 554, referred to as a virtualized traffic adaptor (vModem). The VNF-implemented combiner or a combiner 542 (implemented in hardware) may combine the signal data packets into a digital signal and provide the digital signal to a digitizer 540A, which may convert the digital signal into an analog signal.

The set of VNFs 554 on the return path may comprise or constitute, in order, a digital channelizer (e.g., the OpenSpace™ Wideband Channelizer, offered by Kratos Defense & Security Solutions, Inc. of San Diego, California), a demodulator (e.g., the OpenSpace™ Wideband Software Receiver, offered by Kratos Defense & Security Solutions, Inc. of San Diego, California), and a decapsulator. This set of VNFs 554 on the reception path may convert a digital signal (such as a digital IF waveform or a composite digital IF waveform) to PDUs, which may be Ethernet frames or IP packets, among other possibilities. For example, the VNF-implemented channelizer or a channelizer 544 (implemented in hardware) may receive a digital signal from digitizer 540A, which has converted an analog signal into the digital signal, and divide the digital signal into signal data packets. The demodulator may convert the signal data packets to baseband frames, and provide the baseband frames to the decapsulator. The decapsulator may convert the baseband frames into PDUs, which may be transmitted, via terrestrial network 536, to end point 530A. It should be understood that the demodulator performs the reverse function(s) of the modulator, and the decapsulator performs the reverse function(s) of the encapsulator. In an embodiment, the decapsulator and demodulator may be implemented as a single VNF 554, for example, together with the traffic handler, encapsulator, and modulator, in a vModem. In other words, a vModem may consist of a single VNF 554 that implements all of the functions of the traffic handler, encapsulator/decapsulator, and modulator/demodulator.

In some embodiments, in which gateway service chain 556 implements a vModem, the vModem may comprise one or more modulators that are configured to modulate waveforms according to a digital satellite broadcast standard and/or one or more demodulators that are configured to demodulate waveforms according to a digital satellite broadcast standard. Such a vModem may provide carrier ethernet (CE) services, in which case the vModem may comprise one or more encapsulators that convert Ethernet frames into baseband frames that are modulated into waveforms by the modulator(s), and one or more decapsulators that convert baseband frames, which have been demodulated from waveforms by the demodulator(s), into Ethernet frames. The digital satellite broadcast standard may be a digital satellite television broadcast standard, such as the DVB-S2X standard managed by the Digital Video Broadcasting (DVB) Project. While a digital satellite broadcast standard, such as a DVB standard, is used as an example, the vModem may be configured to modulate and demodulate waveforms according to other standards for wideband digital communication, such as orthogonal frequency-division multiplexing (OFDM), or the like.

The digital signal from combiner 542 is transmitted to digitizer 540A, which converts the digital signal output by combiner 542 into an analog transmission signal for communication to satellite 520. Digitizer 540A further digitizes analog reception signals from satellite 520 into digital signals for use by channelizer 544. In some examples, digitizer 540A may be software-defined. As one example, digitizer 540A may be a SpectralNet™, which is a carrier-grade RF digitizer, offered by Kratos Defense & Security Solutions, Inc. of San Diego, California. Digitizer 540A communicates with antenna 550A. In particular, digitizer 540A provides the transmission signal to antenna 550A, which transmits the transmission signal to satellite 520. In addition, in two-way communications, antenna 550A receives a reception signal from satellite 520, and provides the reception signal to digitizer 540A.

In various examples, antenna 550A may be a parabolic reflector antenna, a flat panel antenna, a phased array antenna, a helical antenna, a patch antenna, a horn antenna, among other possibilities. In some examples, antenna 550A may be an electronically steered antenna that can use electronic means to control the direction and shape of its radiation pattern. Such an antenna can generate multiple beams simultaneously, allowing it to transmit or receive signals in multiple directions at the same time. Antenna 550A may include both the physical antenna as well as the corresponding radio frequency (RF) subsystem, which may include a combination of diplexers, amplifiers (e.g., low noise amplifiers (LNAs)), upconverters, and downconverters (e.g., low-noise block downconverters (LNBs) depending on the specific frequency band and application.

Satellite 520 relays wireless signals from antenna 550A to antenna 550B. In two-way communications, satellite 520 also relays wireless signals from antenna 550B to antenna 550A. Antenna 550B may be functionally similar or identical to antenna 550A, and therefore, any description of antenna 550A applies equally to antenna 550B, which may not be redundantly described herein. Similarly, digitizer 540B may be functionally similar or identical to digitizer 540A, and therefore, any description of digitizer 540A applies equally to digitizer 540B, which may not be redundantly described herein.

Digitizer 540B may communicate directly with a terminal service chain 557 of a terminal compute infrastructure. Terminal service chain 557 may comprise a set of VNF(s) 555 forming a reception path from digitizer 540B to end point 530B. In two-way communications, terminal service chain 557 may also comprise a set of VNFs 555 forming a transmission path from end point 530B to digitizer 540B. The reception and transmission paths may be identical or similar to the reception and transmission paths described with respect to gateway service chain 556. For example, the reception path may comprise a demodulator followed by a decapsulator to convert signal frames into PDUs, and the transmission path may comprise an encapsulator followed by a modulator to convert PDUs into signal frames. The traffic handler, encapslator, decapsulator, modulator, and demodulator may all be similar or identical to those described with respect to gateway service chain 556, and therefore, the descriptions of those components with respect to gateway service chain 556 apply equally to those components in terminal service chain 557.

Terminal service chain 557 may communicate with end point 530B. For example, the traffic handler of terminal service chain 557 may transmit Ethernet frames to end point 530B. In addition, in two-way communications, the encapsulator of terminal service chain 557 may receive PDUs from end point 530B. Thus, the combination of gateway service chain 556 and terminal service chain 557 enable one-way or two-way communications between end points 510A and 510B over a satellite link.

Gateway service chain 556 and terminal service chain 557 may comprise one or more of the software-defined components (e.g., VNFs and/or digitizers) described in International Patent App. Nos. PCT/US2021/033867, filed on May 24, 2021, PCT/US2021/033875, filed on May 24, 2021, PCT/US2021/033905, filed on May 24, 2021, and PCT/US2021/062689, filed on Dec. 9, 2021, which are all hereby incorporated herein by reference as if set forth in full.

Advantageously, the utilization of VNFs and software-defined components (e.g., digitizers 540A and 540B) to perform various functions, aid in automation and scalability. Embodiments may minimize the presence of physical hardware components, such that satellite communication system 500 can be dynamically reconfigured (e.g., added, updated, destroyed, increased or decreased in dimension, etc.) in real time, primarily using in-band network communications, to adapt to the unique multivariate satcom environment (e.g., changing traffic patterns, RF interference, atmospheric characteristics, antenna conditions, path length, etc.).

Notably, dynamic reconfiguration of VNFs in a cloud computing environment can be used, not only to increase the dimensions of the computing resources (e.g., number of vCPUs, amount of memory and/or disk storage, network throughput, etc.) used for satellite communication system 500 on demand to ensure the sufficiency of the satellite communication system, but also to decrease the dimensions of the computing resources on demand to optimize the utilization of the hardware. For example, favorable changes in the satcom environment may improve performance of satellite communication system 500, such that satellite communication system 500 is providing significantly better performance than is required by the service level agreement. In this case, the management system may determine that gateway service chain 556 and terminal service chain 557 are insufficient, and update the service chains to reduce the resources used in the service chains (e.g., by reducing RF bandwidth usage, resizing one or more VNFs, swapping to a service chain with reduced dimensions, etc.). This is in contrast to conventional hardware-based service chains in which unused resources would simply be idled or otherwise ignored, representing a sunk cost that cannot be recouped.

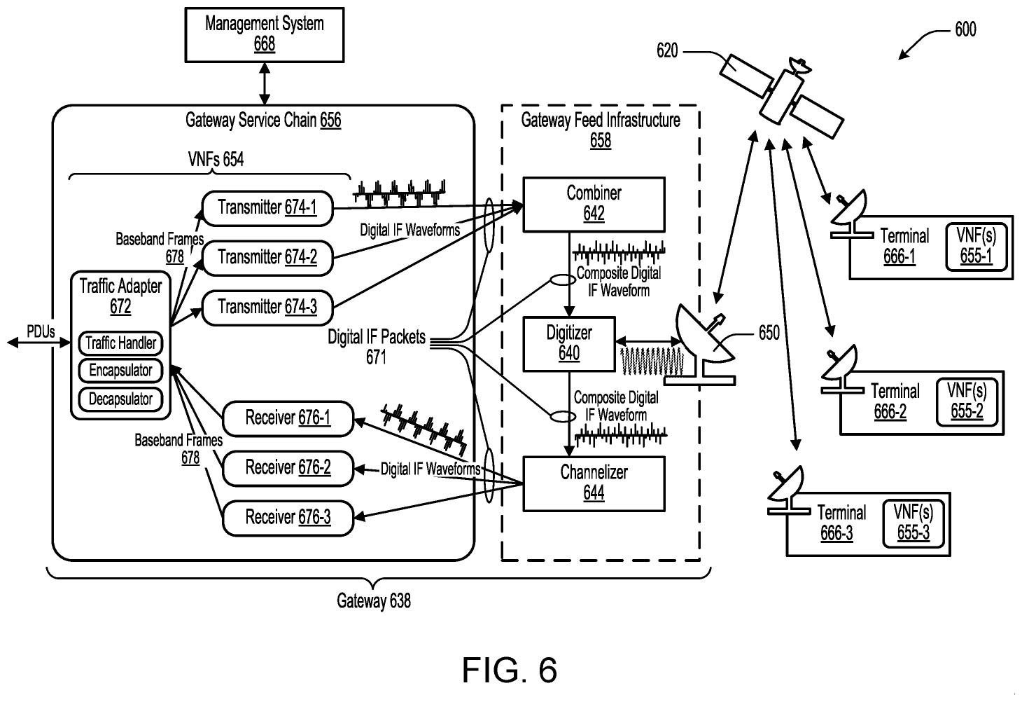

FIG. 6 illustrates an example satellite communication system 600 including a gateway 638 and a set of terminals 666 (or “remote terminals”), in accordance with some embodiments of the present disclosure. In the illustrated example, satellite communication system 600 includes a gateway 638 (or “hub”) in communication with each of terminals 666 via a satellite 620. Gateway 638 may include a gateway feed infrastructure 658 that serves as an onsite infrastructure (close to antenna 650, e.g., at a same physical location) that may perform primarily signal digitization and signal routing-related tasks and a gateway compute infrastructure that can be onsite or offsite infrastructure (far from antenna 650, e.g., at a different physical location) that supports a gateway service chain 656 that performs primarily signal processing and packet processing-related tasks. The gateway compute infrastructure may include one or more computers, clusters, a data center, or a warehouse-scale computer. The computing devices comprising the gateway compute infrastructure and/or gateway feed infrastructure 658 may include general-purpose computers or servers employing x86 architectures, ARM architectures, RISC-V architectures, among other possibilities.

Gateway 638 may include a gateway service chain 656 comprising a set of VNFs 654 running on the gateway compute infrastructure. Example VNFs include one or more traffic adapters 672, one or more virtual transmitters 674, one or more virtual receivers 676, among other possibilities. Each of VNFs 654 may be instantiated and configured by a management system 668 that scales up or down the number of active VNFs based on the number of active terminals 666. Management system 668 may further configure VNFs 654 such that satellite communication system 600 implements any one of a number of network topologies, including a single channel per carrier (SCPC) network, a TDMA network, a frequency division multiple access (FDMA) network, a mesh network, among other possibilities.

VNFs 654 may include one or more virtual transmitters 674 that provide one or more transmission paths between a terrestrial network and a gateway feed infrastructure 658 of gateway 656. Each of the set of virtual transmitters 674 on a transmission path may comprise or constitute a modulator (e.g., the OpenSpace™ Wideband Software modulator) that converts incoming baseband frames 678 into digital IF packets 671 containing digital waveforms at IF or RF frequencies (or “digital IF waveforms”). Traffic adapter 672 acts as the bridge between the terrestrial network and the satellite network. In some examples, traffic adapter 672 may include a traffic handler that processes data link layer (e.g., Layer 2 in the OSI model) and/or network layer (e.g., Layer 3 in the OSI model) traffic and provides the processed PDUs to the encapsulator, which convert the PDUs into baseband frames 678 and provides baseband frames 678 to one of virtual transmitters 674. Each of virtual transmitters 674 may implement a modulator that converts baseband frames 678 into digital IF packets 671 (e.g., according to the standards of the DIFI Consortium in the DIFI/IEEE 1.2 specification) to create the digital IF waveforms.

Digital IF packets 671 generated by virtual transmitters 674 may be fed into a combiner 642 that combines the multiple digital IF waveforms into a single composite signal (or “composite digital IF waveform”). Digital IF packets 671 containing the composite digital IF waveform is fed into a digitizer 640 that converts the digital signal into an analog signal in preparation for wireless transmission via an antenna 650. While combiner 642 is illustrated in FIG. 6 as being an element of gateway feed infrastructure 658, it is to be understood that a combiner VNF (or multiple combiner VNFs) may be instantiated by management system 668 to perform similar functionality.

On the reception path, digitizer 640 digitizes analog signals received from satellite 620 to generate digital IF packets 671 containing digital IF waveforms (e.g., a composite digital IF waveform) of the received analog signals for use by a channelizer 644. The composite digital IF waveform received by channelizer 644 may be a wide-band spectrum (e.g., 100 MHz, 500 MHz, 300 GHz, etc.) that may contain several signals within that segment of the frequency band. In some instances, channelizer 644 divides the composite digital IF waveform into separate digital IF waveforms and sends the waveforms (in the form of digital IF packets 671) to appropriate virtual receivers 676. While channelizer 644 is illustrated in FIG. 6 as being an element of gateway feed infrastructure 658, it is to be understood that a channelizer VNF (or multiple channelizer VNFs) may be instantiated by management system 668 to perform similar functionality. VNFs 654 may include one or more virtual receivers 676 that provide one or more reception paths between gateway feed infrastructure 658 and a terrestrial network. Each of the set of virtual receivers 676 on a reception path may comprise or constitute a demodulator (e.g., the OpenSpace™ Wideband Software Receiver) that converts incoming digital IF packets 671 containing digital IF waveforms into baseband frames 678. In some examples, baseband frames 678 produced by virtual receivers are sent to the decapsulator of traffic adapter 672. The decapsulator may convert baseband frames 678 into Ethernet frames and pass the Ethernet frames to the traffic handler, which processes and provides the Ethernet frames to a terrestrial network.

Satellite 620 relays wireless signals from antenna 650 to the antennas of terminals 666, or vice versa. In two-way communications, satellite 620 also relays wireless signals from the antennas of terminals 666 to antenna 650. In some examples, each of terminals 666 may include hardware infrastructure to support one or more VNFs 655. In some examples, VNFs 655 at each of terminals 666 may implement a vModem that comprises one or more modulators that are configured to modulate waveforms according to a digital satellite broadcast standard and/or one or more demodulators that are configured to demodulate waveforms according to the digital satellite broadcast standard. Such a vModem may provide CE services, in which case the vModem may comprise one or more encapsulators that convert Ethernet frames into baseband frames that are modulated into waveforms by the modulator(s), and one or more decapsulators that convert baseband frames, which have been demodulated from waveforms by the demodulator(s), into Ethernet frames, together with a traffic handler that connects the encapsulators and decapsulators with the terrestrial networks connected to terminals 666.

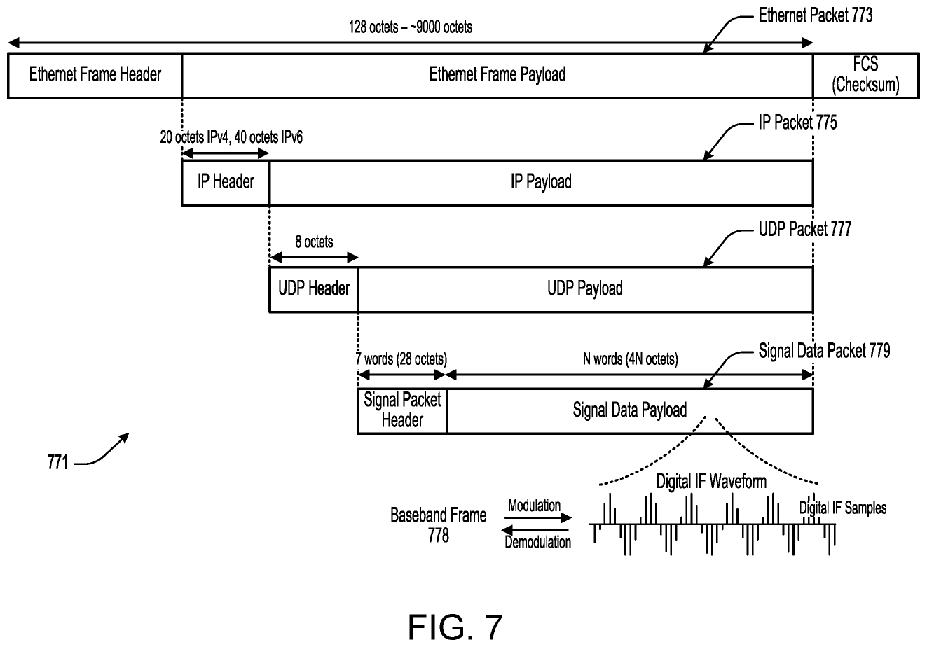

FIG. 7 illustrates an example digital IF packet 771 with multiple protocol layers, in accordance with some embodiments of the present disclosure. In the illustrated example, digital IF packet 771 includes a digital IF waveform contained within the signal data payload of a signal data packet 779. The digital IF waveform may represent the modulated form of one or more baseband frames 778 (or portions of one or more baseband frames 778), such that the baseband frames may be recovered by demodulating the digital IF waveform contained within the signal data payload. Signal data packet 779 may also include a signal packet header, which may implement the VITA standard (e.g., VITA 49.2 specification) or another standard.

In some examples, signal data packet 779 is encapsulated within a UDP packet 777 having a UDP header and UDP payload. UDP packet 777 may be encapsulated within an IP packet 775 having an IP header and IP payload, which may be encapsulated within an Ethernet packet 773 having an Ethernet frame header and Ethernet frame payload. In some examples, the total Ethernet packet size varies based on the number and size of the data samples in the signal data payload of signal data packet 779. There may be a fixed overhead within the Ethernet frame which comprises the IP header (20 octets for IPV4 or 40 octets (minimum) for IPV6), the UDP header (8 octets), the signal packet header (28 octets). In some examples, the Ethernet frame payload is adjustable from 128 octets to approximately 9000 octets.

In some examples, digital IF packet 771 may include different packet classes for signal data packet 779. In a first packet class, signal data packet 779 may be a regular data packet that includes the data for the digital samples forming the digital IF waveform. In a second packet class, signal data packet 779 may be a context packet that includes data to ensure standardization of the transport of metadata describing the sampled signal data. Such data may include the IF reference frequency, the sample rate, the bit depth, the equivalent analog bandwidth of the signal represented by the digital stream, the frequency offset of the center of the band occupied by the signal from the IF reference frequency, among other possibilities. In a third packet class, signal data packet 779 may be a command packet that includes data used to provide and acknowledge device settings and support control of timing to permit synchronization of upstream or downstream devices.

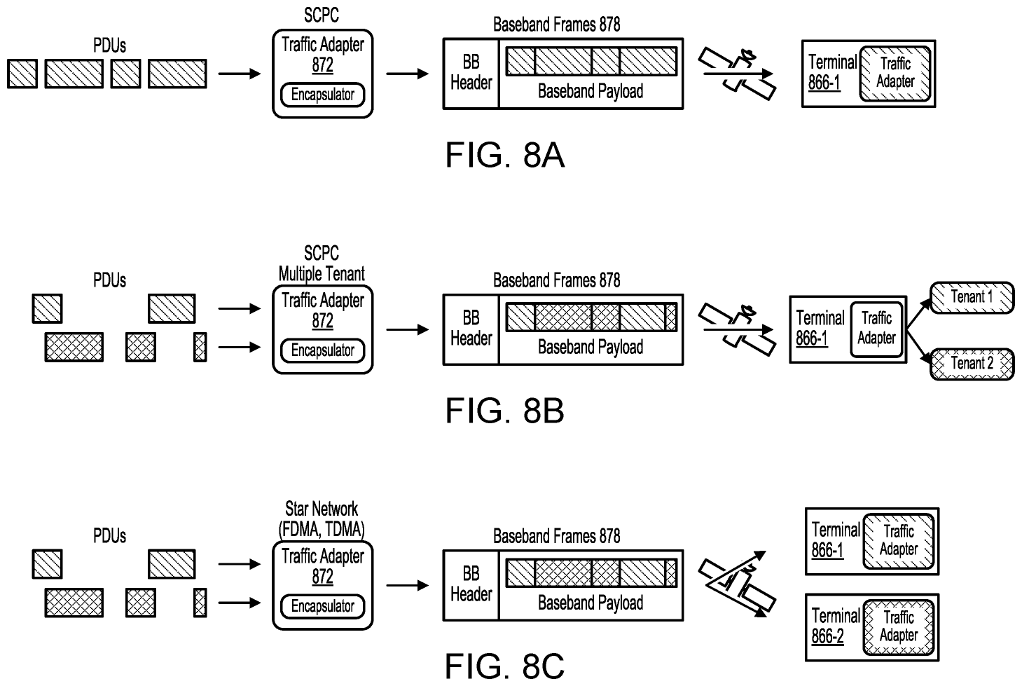

FIGS. 8A-8C illustrate example traffic adapters 872 implementing different network types, in accordance with some embodiments of the present disclosure. In FIG. 8A, traffic adapter 872 is configured by the management system to implement a SCPC (single tenant) network connection type. The encapsulator processes incoming PDUs destined for a terminal 866-1 by encapsulating the PDUs into a baseband frame 878 and adding an encapsulation header to each PDU and a baseband header to the entire baseband frame 878. The encapsulation headers (based on ETSI TS 102 606) include an identifier for terminal 866-1, an identifier of the encapsulated PDU's type, and an indicator of the length of the PDU. They may further include information to allow splitting an encapsulated PDU into multiple fragments to be distributed over multiple baseband frames 878. The baseband header includes, among other elements, information about the contained encapsulation structure and the total size of the payload. Upon receiving baseband frame 878, a traffic adapter of terminal 866-1 may decapsulate the baseband frame to recover the PDUs.

In FIG. 8B, traffic adapter 872 is configured by the management system to implement a SCPC (multiple tenant) network connection type. The encapsulator processes a first set of PDUs destined for Tenant 1 via terminal 866-1 and a second set of PDUs destined for Tenant 2 via terminal 866-1 by encapsulating both sets of PDUs (received within a particular time window) into a single baseband frame 878 and adding a baseband header to baseband frame 878 and individual encapsulation headers to each PDU. The encapsulation headers may include an identifier for Tenant 1, an identifier for Tenant 2, an indicator of the encapsulated PDU's content, an indicator of the size of the encapsulated PDU, and information about fragmentation of the encapsulated PDU across multiple baseband frames 878, among other possibilities. The baseband header includes, among other elements, information about the contained encapsulation structure and the total size of the payload. Upon receiving baseband frame 878, the traffic adapter of terminal 866-1 may decapsulate baseband frame 878 to recover and separate the PDUs, and may route the PDUstoward Tenant 1 and Tenant 2 as appropriate.

In FIG. 8C, traffic adapter 872 is configured by the management system to implement an FDMA or TDMA network connection type. The encapsulator processes a first set of PDUs destined for terminal 866-1 and a second set of PDUsdestined for terminal 866-2 by encapsulating both sets of PDUs (received within a particular time window) into a single baseband frame 878 and adding a baseband header to baseband frame 878 and individual encapsulation headers to each PDU. The encapsulation headers include an identifier for terminal 366-1, an identifier for terminal 366-2, an indicator of the encapsulated PDU's content, an indicator of the size of the encapsulated PDU, and information about fragmentation of the encapsulated PDU across multiple baseband frames 878, among other possibilities. They may further include information to allow splitting an encapsulated PDU into multiple fragments to be distributed over multiple baseband frames 878. The baseband header includes, among other elements, information about the contained encapsulation structure and the total size of the payload. Upon receiving baseband frame 878, the traffic adapter of terminal 866-1 may decapsulate baseband frame 878 to recover the PDUs destined for terminal 866-1, and the traffic adapter of terminal 866-2 may decapsulate baseband frame 878 to recover the PDUs destined for terminal 866-2.

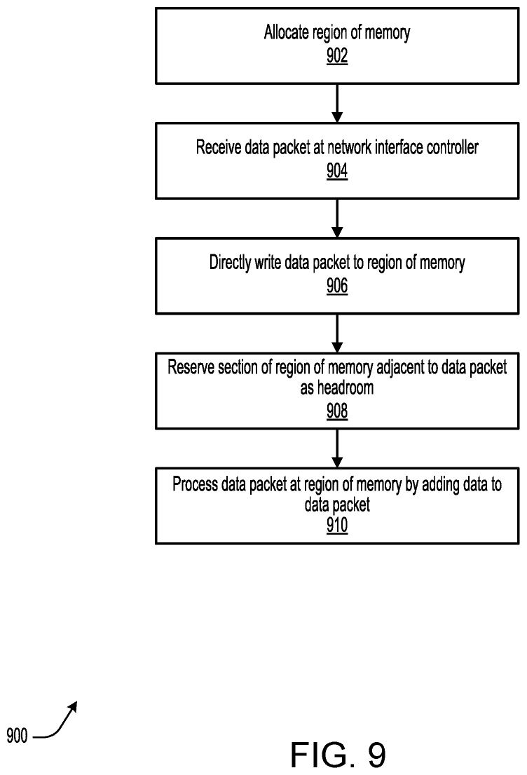

FIG. 9 illustrates a method 900 of processing data packets at a compute infrastructure, in accordance with some embodiments of the present disclosure. Steps of method 900 may be performed in any order and/or in parallel, and one or more steps of method 900 may be optionally performed. One or more steps of method 900 may be performed by one or more processors. Method 900 may be implemented as a computer-readable medium or computer program product comprising instructions which, when the program is executed by one or more processors, cause the one or more processors to carry out the steps of method 900.

At step 902, a region (e.g., shared memory regions 112, 212, 312, 412) of a memory (e.g., memories 110, 410) is allocated for a network interface controller (e.g., network interface controllers 106, 406) to write or read inbound or outbound data packets. The region of the memory may be allocated by an application (e.g., applications 102, 402) running on a compute infrastructure (e.g., compute infrastructures 160, 460, 560). For example, the application may allocate the region of the memory for the network interface controller to write inbound data packets that are received at the network interface controller or to read outbound data packets that are to be transmitted at the network interface controller. The compute infrastructure may be part of a gateway (e.g., gateways 538, 638) or a terminal (e.g., terminals 566, 666, 866) of a satellite communication system (e.g., satellite communication systems 500, 600). The application may include one or more VNFs (e.g., VNFs 554, 555, 654) running on the compute infrastructure.

At step 904, a data packet (e.g., data packets 108, 208, 308, 408) is received at the network interface controller. The data packet may be received over a terrestrial network. In some examples, a second data packet may be received at the network interface controller (the data packet being a first data packet).

At step 906, the data packet is directly written to the region of the memory. The data packet may be directly written to the region of the memory by the network interface controller, optionally through the use of an NIC driver (e.g., NIC drivers 116, 416). In some examples, the second data packet may also be written to the region of the memory.

At step 908, a section of the region of the memory adjacent to the data packet is reserved as headroom (e.g., headrooms 114, 214, 314, 414) such that a memory address occupied by the data packet is adjacent to a memory address occupied by the headroom. The section of the region of the memory may be reserved as the headroom by the network interface controller optionally through the use of the NIC driver. In some examples, a second section of the region of the memory adjacent to the second data packet is reserved as second headroom (the section being a first section).

At step 910, the data packet is processed by the application at the region of the memory. The data packet may be processed by adding data to the data packet, where adding the data to the data packet causes the data packet to use at least a portion of the headroom.

Processing the data packet at the region of the memory may include encapsulating the data packet within a baseband frame (e.g., baseband frames 278, 378, 678, 778, 878) for transmission via a satellite (e.g., satellites 520, 620). In some examples, the second data packet is also processed by the application at the region of the memory by adding second data to the data packet. In some examples, processing the first data packet and the second data packet may include encapsulating the first data packet and the second data packet within the baseband frame for transmission via the satellite.

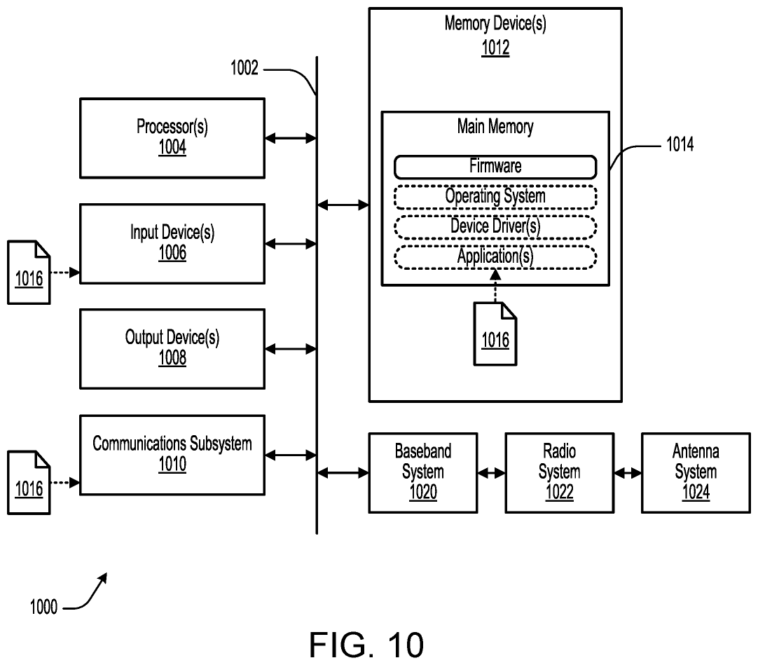

FIG. 10 illustrates an example computer system 1000 comprising various hardware elements, in accordance with some embodiments of the present disclosure. Computer system 1000 may be incorporated into or integrated with devices described herein and/or may be configured to perform some or all of the steps of the methods provided by various embodiments. It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner.

In the illustrated example, computer system 1000 includes a communication medium 1002, one or more processor(s) 1004, one or more input device(s) 1006, one or more output device(s) 1008, a communications subsystem 1010, one or more memory device(s) 1012, a baseband system 1020, a radio system 1022, and an antenna system 1024. Computer system 1000 may be implemented using various hardware implementations and embedded system technologies. For example, one or more elements of computer system 1000 may be implemented within an integrated circuit (IC), an application-specific integrated circuit (ASIC), an application-specific standard product (ASSP), a field-programmable gate array (FPGA), such as those commercially available by XILINX®, INTEL®, or LATTICE SEMICONDUCTOR®, a system-on-a-chip (SoC), a microcontroller, a printed circuit board (PCB), and/or a hybrid device, such as an SoC FPGA, among other possibilities.

The various hardware elements of computer system 1000 may be communicatively coupled via communication medium 1002. While communication medium 1002 is illustrated as a single connection for purposes of clarity, it should be understood that communication medium 1002 may include various numbers and types of communication media for transferring data between hardware elements. For example, communication medium 1002 may include one or more wires (e.g., conductive traces, paths, or leads on a PCB or integrated circuit (IC), microstrips, striplines, coaxial cables), one or more optical waveguides (e.g., optical fibers, strip waveguides), and/or one or more wireless connections or links (e.g., infrared wireless communication, radio communication, microwave wireless communication), among other possibilities.

In some embodiments, communication medium 1002 may include one or more buses that connect the pins of the hardware elements of computer system 1000. For example, communication medium 1002 may include a bus that connects processor(s) 1004 with main memory 1014, referred to as a system bus, and a bus that connects main memory 1014 with input device(s) 1006 or output device(s) 1008, referred to as an expansion bus. The system bus may itself consist of several buses, including an address bus, a data bus, and a control bus. The address bus may carry a memory address from processor(s) 1004 to the address bus circuitry associated with main memory 1014 in order for the data bus to access and carry the data contained at the memory address back to processor(s) 1004. The control bus may carry commands from processor(s) 1004 and return status signals from main memory 1014. Each bus may include multiple wires for carrying multiple bits of information and each bus may support serial or parallel transmission of data.

Processor(s) 1004 may include one or more central processing units (CPUs), graphics processing units (GPUs), neural network processors or accelerators, digital signal processors (DSPs), and/or other general-purpose or special-purpose processors capable of executing instructions. A CPU may take the form of a microprocessor, which may be fabricated on a single IC chip of metal-oxide-semiconductor field-effect transistor (MOSFET) construction. Processor(s) 1004 may include one or more multi-core processors, in which each core may read and execute program instructions concurrently with the other cores, increasing speed for programs that support multithreading.

Input device(s) 1006 may include one or more of various user input devices such as a mouse, a keyboard, a microphone, as well as various sensor input devices, such as an image capture device, a temperature sensor (e.g., thermometer, thermocouple, thermistor), a pressure sensor (e.g., barometer, tactile sensor), a movement sensor (e.g., accelerometer, gyroscope, tilt sensor), a light sensor (e.g., photodiode, photodetector, charge-coupled device), and/or the like. Input device(s) 1006 may also include devices for reading and/or receiving removable storage devices or other removable media. Such removable media may include optical discs (e.g., Blu-ray discs, DVDs, CDs), memory cards (e.g., CompactFlash card, Secure Digital (SD) card, Memory Stick), floppy disks, Universal Serial Bus (USB) flash drives, external hard disk drives (HDDs) or solid-state drives (SSDs), and/or the like.

Output device(s) 1008 may include one or more of various devices that convert information into human-readable form, such as without limitation a display device, a speaker, a printer, a haptic or tactile device, and/or the like. Output device(s) 1008 may also include devices for writing to removable storage devices or other removable media, such as those described in reference to input device(s) 1006. Output device(s) 1008 may also include various actuators for causing physical movement of one or more components. Such actuators may be hydraulic, pneumatic, electric, and may be controlled using control signals generated by computer system 1000.

Communications subsystem 1010 may include hardware components for connecting computer system 1000 to systems or devices that are located external to computer system 1000, such as over a computer network. In various embodiments, communications subsystem 1010 may include a wired communication device coupled to one or more input/output ports (e.g., a universal asynchronous receiver-transmitter (UART)), an optical communication device (e.g., an optical modem), an infrared communication device, a radio communication device (e.g., a wireless network interface controller, a BLUETOOTH® device, an IEEE 802.11 device, a Wi-Fi device, a Wi-Max device, a cellular device), among other possibilities.

Memory device(s) 1012 may include the various data storage devices of computer system 1000. For example, memory device(s) 1012 may include various types of computer memory with various response times and capacities, from faster response times and lower capacity memory, such as processor registers and caches (e.g., L0, L1, L2), to medium response time and medium capacity memory, such as random-access memory (RAM), to lower response times and lower capacity memory, such as solid-state drives and hard drive disks. While processor(s) 1004 and memory device(s) 1012 are illustrated as being separate elements, it should be understood that processor(s) 1004 may include varying levels of on-processor memory, such as processor registers and caches that may be utilized by a single processor or shared between multiple processors.

Memory device(s) 1012 may include main memory 1014, which may be directly accessible by processor(s) 1004 via the address and data buses of communication medium 1002. For example, processor(s) 1004 may continuously read and execute instructions stored in main memory 1014. As such, various software elements may be loaded into main memory 1014 to be read and executed by processor(s) 1004 as illustrated in FIG. 10. Typically, main memory 1014 is volatile memory, which loses all data when power is turned off and accordingly needs power to preserve stored data. Main memory 1014 may further include a small portion of non-volatile memory containing software (e.g., firmware, such as BIOS) that is used for reading other software stored in memory device(s) 1012 into main memory 1014. In some embodiments, the volatile memory of main memory 1014 is implemented as RAM, such as dynamic random-access memory (DRAM), and the non-volatile memory of main memory 1014 is implemented as read-only memory (ROM), such as flash memory, erasable programmable read-only memory (EPROM), or electrically erasable programmable read-only memory (EEPROM).

Computer system 1000 may include software elements, shown as being currently located within main memory 1014, which may include an operating system, device driver(s), firmware, compilers, and/or other code, such as one or more application programs, which may include computer programs provided by various embodiments of the present disclosure. Merely by way of example, one or more steps described with respect to any methods discussed above, may be implemented as instructions 1016, which are executable by computer system 1000. In one example, such instructions 1016 may be received by computer system 1000 using communications subsystem 1010 (e.g., via a wireless or wired signal that carries instructions 1016), carried by communication medium 1002 to memory device(s) 1012, stored within memory device(s) 1012, read into main memory 1014, and executed by processor(s) 1004 to perform one or more steps of the described methods. In another example, instructions 1016 may be received by computer system 1000 using input device(s) 1006 (e.g., via a reader for removable media), carried by communication medium 1002 to memory device(s) 1012, stored within memory device(s) 1012, read into main memory 1014, and executed by processor(s) 1004 to perform one or more steps of the described methods.

Computer system 1000 may include optional wireless communication components that facilitate wireless communication over a voice network and/or a data network. The wireless communication components comprise an antenna system 1024, a radio system 1022, and a baseband system 1020. In computer system 1000, RF signals are transmitted and received over the air by antenna system 1024 under the management of radio system 1022. In an embodiment, antenna system 1024 may comprise one or more antennae and one or more multiplexors (not shown) that perform a switching function to provide antenna system 1024 with transmit and receive signal paths. In the reception path, received RF signals can be coupled from a multiplexor to a low noise amplifier (not shown) that amplifies the received RF signal and sends the amplified signal to radio system 1022. In an alternative embodiment, radio system 1022 may comprise one or more radios that are configured to communicate over various frequencies. In an embodiment, radio system 1022 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 1022 to baseband system 1020.

In some embodiments of the present disclosure, instructions 1016 are stored on a computer-readable storage medium (or simply computer-readable medium). Such a computer-readable medium may be non-transitory and may therefore be referred to as a non-transitory computer-readable medium. In some cases, the non-transitory computer-readable medium may be incorporated within computer system 1000. For example, the non-transitory computer-readable medium may be one of memory device(s) 1012 (as shown in FIG. 10). In some cases, the non-transitory computer-readable medium may be separate from computer system 1000. In one example, the non-transitory computer-readable medium may be a removable medium provided to input device(s) 1006 (as shown in FIG. 10), such as those described in reference to input device(s) 1006, with instructions 1016 being read into computer system 1000 by input device(s) 1006. In another example, the non-transitory computer-readable medium may be a component of a remote electronic device, such as a mobile phone, that may wirelessly transmit a data signal that carries instructions 1016 to computer system 1000 and that is received by communications subsystem 1010 (as shown in FIG. 10).

Instructions 1016 may take any suitable form to be read and/or executed by computer system 1000. For example, instructions 1016 may be source code (written in a human-readable programming language such as Java, C, C++, C#, Python), object code, assembly language, machine code, microcode, executable code, and/or the like. In one example, instructions 1016 are provided to computer system 1000 in the form of source code, and a compiler is used to translate instructions 1016 from source code to machine code, which may then be read into main memory 1014 for execution by processor(s) 1004. As another example, instructions 1016 are provided to computer system 1000 in the form of an executable file with machine code that may immediately be read into main memory 1014 for execution by processor(s) 1004. In various examples, instructions 1016 may be provided to computer system 1000 in encrypted or unencrypted form, compressed or uncompressed form, as an installation package or an initialization for a broader software deployment, among other possibilities.

In one aspect of the present disclosure, a system (e.g., computer system 1000) is provided to perform methods in accordance with various embodiments of the present disclosure. For example, some embodiments may include a system comprising one or more processors (e.g., processor(s) 1004) that are communicatively coupled to a non-transitory computer-readable medium (e.g., memory device(s) 1012 or main memory 1014). The non-transitory computer-readable medium may have instructions (e.g., instructions 1016) stored therein that, when executed by the one or more processors, cause the one or more processors to perform the methods described in the various embodiments.

In another aspect of the present disclosure, a computer-program product that includes instructions (e.g., instructions 1016) is provided to perform methods in accordance with various embodiments of the present disclosure. The computer-program product may be tangibly embodied in a non-transitory computer-readable medium (e.g., memory device(s) 1012 or main memory 1014). The instructions may be configured to cause one or more processors (e.g., processor(s) 1004) to perform the methods described in the various embodiments.

In another aspect of the present disclosure, a non-transitory computer-readable medium (e.g., memory device(s) 1012 or main memory 1014) is provided. The non-transitory computer-readable medium may have instructions (e.g., instructions 1016) stored therein that, when executed by one or more processors (e.g., processor(s) 1004), cause the one or more processors to perform the methods described in the various embodiments.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes reference to one or more of such users, and reference to “a processor” includes reference to one or more processors and equivalents thereof known to those skilled in the art, and so forth.

Also, the words “comprise,” “comprising,” “contains,” “containing,” “include,” “including,” and “includes,” when used in this specification and in the following claims, are intended to specify the presence of stated features, integers, components, or steps, but they do not preclude the presence or addition of one or more other features, integers, components, steps, acts, or groups.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of processing data packets at a compute infrastructure, the method comprising:
allocating, by an application running on the compute infrastructure, a region of a memory for a network interface controller to write or read inbound or outbound data packets;
receiving a data packet at the network interface controller;
directly writing the data packet to the region of the memory;
reserving a section of the region of the memory adjacent to the data packet as headroom such that a memory address occupied by the data packet is adjacent to a memory address occupied by the headroom; and
processing, by the application, the data packet at the region of the memory by adding data to the data packet, wherein adding the data to the data packet causes the data packet to use at least a portion of the headroom.

2. The method of claim 1, further comprising:
in response to allocating the region of the memory, instructing, by the application, the network interface controller to read or write the outbound or inbound data packets from/to the region of the memory.

3. The method of claim 1, further comprising:
receiving a second data packet at the network interface controller, wherein the data packet is a first data packet;
directly writing the second data packet to the region of the memory;
reserving a second section of the region of the memory adjacent to the second data packet as second headroom such that a memory address occupied by the second data packet is adjacent to a memory address occupied by the second headroom; and
processing, by the application, the second data packet at the region of the memory by adding second data to the data packet, wherein adding the second data to the second data packet causes the second data packet to use at least a portion of the second headroom;
wherein processing the first data packet and the second data packet includes encapsulating the first data packet and the second data packet within a baseband frame for transmission via a satellite.

4. The method of claim 1, further comprising:
in response to writing the data packet to the region of the memory, sending, by the network interface controller, an event to the application indicating that the data packet has been written to the region of the memory.

5. The method of claim 4, wherein the event further indicates the memory address occupied by the data packet.

6. The method of claim 1, wherein processing the data packet at the region of the memory further includes:
encapsulating the data packet within a baseband frame for transmission via a satellite.

7. The method of claim 1, wherein the application includes one or more virtual network functions (VNF) running on the compute infrastructure.

8. The method of claim 1, wherein the compute infrastructure is part of a gateway of a satellite communication system.

9. The method of claim 1, wherein the compute infrastructure is part of a terminal of a satellite communication system.

10. The method of claim 1, wherein the data packet is received over a terrestrial network.

11. A non-transitory computer-readable medium comprising instructions that, when executed by one or more processors, cause the one or more processors to perform operations for processing data packets at a compute infrastructure, the operations comprising:
allocating, by an application running on the compute infrastructure, a region of a memory for a network interface controller to write or read inbound or outbound data packets;
receiving a data packet at the network interface controller;
directly writing the data packet to the region of the memory;
reserving a section of the region of the memory adjacent to the data packet as headroom such that a memory address occupied by the data packet is adjacent to a memory address occupied by the headroom; and
processing, by the application, the data packet at the region of the memory by adding data to the data packet, wherein adding the data to the data packet causes the data packet to use at least a portion of the headroom.

12. The non-transitory computer-readable medium of claim 11, wherein the operations further comprise:
in response to allocating the region of the memory, instructing, by the application, the network interface controller to read or write the outbound or inbound data packets from/to the region of the memory.

13. The non-transitory computer-readable medium of claim 11, wherein the operations further comprise:
receiving a second data packet at the network interface controller, wherein the data packet is a first data packet;
directly writing the second data packet to the region of the memory;
reserving a second section of the region of the memory adjacent to the second data packet as second headroom such that a memory address occupied by the second data packet is adjacent to a memory address occupied by the second headroom; and
processing, by the application, the second data packet at the region of the memory by adding second data to the data packet, wherein adding the second data to the second data packet causes the second data packet to use at least a portion of the second headroom;
wherein processing the first data packet and the second data packet includes encapsulating the first data packet and the second data packet within a baseband frame for transmission via a satellite.

14. The non-transitory computer-readable medium of claim 11, wherein the operations further comprise:
in response to writing the data packet to the region of the memory, sending, by the network interface controller, an event to the application indicating that the data packet has been written to the region of the memory.

15. The non-transitory computer-readable medium of claim 14, wherein the event further indicates the memory address occupied by the data packet.

16. The non-transitory computer-readable medium of claim 11, wherein processing the data packet at the region of the memory further includes:
encapsulating the data packet within a baseband frame for transmission via a satellite.

17. A system comprising:
one or more processors; and
a non-transitory computer-readable medium comprising instructions that, when executed by the one or more processors, cause the one or more processors to perform operations for processing data packets at a compute infrastructure, the operations comprising:
allocating, by an application running on the compute infrastructure, a region of a memory for a network interface controller to write or read inbound or outbound data packets;
receiving a data packet at the network interface controller;
directly writing the data packet to the region of the memory;
reserving a section of the region of the memory adjacent to the data packet as headroom such that a memory address occupied by the data packet is adjacent to a memory address occupied by the headroom; and
processing, by the application, the data packet at the region of the memory by adding data to the data packet, wherein adding the data to the data packet causes the data packet to use at least a portion of the headroom.

18. The system of claim 17, wherein the operations further comprise:
in response to allocating the region of the memory, instructing, by the application, the network interface controller to read or write the outbound or inbound data packets from/to the region of the memory.

19. The system of claim 17, wherein the operations further comprise:
receiving a second data packet at the network interface controller, wherein the data packet is a first data packet;
directly writing the second data packet to the region of the memory;
reserving a second section of the region of the memory adjacent to the second data packet as second headroom such that a memory address occupied by the second data packet is adjacent to a memory address occupied by the second headroom; and
processing, by the application, the second data packet at the region of the memory by adding second data to the data packet, wherein adding the second data to the second data packet causes the second data packet to use at least a portion of the second headroom;
wherein processing the first data packet and the second data packet includes encapsulating the first data packet and the second data packet within a baseband frame for transmission via a satellite.

20. The system of claim 17, wherein the operations further comprise:
in response to writing the data packet to the region of the memory, sending, by the network interface controller, an event to the application indicating that the data packet has been written to the region of the memory.
